(19) United States
(12) Patent Application Publication
(10) Pub. No.: US 2024/0422667 A1
(43) Pub. Date: Dec. 19, 2024

(54) ADAPTIVE DYNAMIC PROGRAMMING FOR ENERGY-EFFICIENT BASE STATION CELL SWITCHING

(71) Applicant: SAMSUNG ELECTRONICS CO., LTD., Suwon-si (KR)

(72) Inventors: Junliang LUO, Lasalle (CA); Yi Tian Xu, Mont-Royal (CA); Di Wu, Saint-Laurent (CA); Xue Liu, Montreal (CA); Gregory Lewis Dudek, Westmount (CA)

(73) Assignee: SAMSUNG ELECTRONICS CO., LTD., Suwon-si (KR)

(21) Appl. No.: 18/631,726

(22) Filed: Apr. 10, 2024

Related U.S. Application Data
(60) Provisional application No. 63/521,046, filed on Jun. 14, 2023.

(51) Int. Cl. H04W 52/02; H04L 41/16; H04W 28/24

(52) U.S. Cl. CPC H04W 52/0206; H04L 41/16; H04W 28/24

(57) ABSTRACT

A method performed by at least one processor of a network device in communication with a plurality of base stations, the method including: receiving historical data collected by one or more base stations from the plurality of base stations, the historical data indicating one or more of a power consumption, handover data, and quality of service (QOS); generating, from the historical data, training data comprising a plurality of cell states and a corresponding random action for each cell state; and training one or more neural network estimators based on the training data, where the one or more neural network estimators comprise one or more of a power consumption estimator, a QoS estimator, and a handover prediction estimator, and where each base station from the plurality of base stations is associated with a respective cell.

### CROSS-REFERENCE TO RELATED APPLICATION

This application claims priority to U.S. provisional application No. 63/521,046 filed on Jun. 14, 2023, the entire contents of which are incorporated herein by reference.

### BACKGROUND

### 1. Field

This disclosure is directed to adaptive dynamic programming for energy-efficient base station cell switching.

### 2. Related Art

The energy consumption of global 5G infrastructure has reached an unprecedented scale. Base stations in a 5G infrastructure require massive energy to operate since 5G base stations have to be more densely deployed than 4G base stations due to the fact that the coverage radius of 5G is relatively small since high-frequency bands have smaller convergence compared to low-frequency bands. Improving energy efficiency allows a reduction in global greenhouse gas emissions, saving the cost for the telecommunication operators, and complying with the energy consumption regulations of the telecommunication industry in many countries. Other attention to energy saving in 5G networks is caused by the rising concern of the potential energy crisis.

Algorithms for limiting energy consumption in WiMAX and LTE networks have previously received significant attention from the research community leading to some promising results. Among those works, energy saving was formulated into optimization problems with the goal of optimizing the energy efficiency of the data transmission process, optimizing the positioning of base stations during the deployment, and optimizing the on/off status of base stations, etc. Base station switching (e.g., selectively switching off components with low usage in base stations, is considered to be a flexible solution due to its fast adaptability without requiring to change any physical components in base stations. However, finding a strategy to maximize energy saved without deteriorating the QoS is challenging.

Base station switching strategy concerns mostly the network performance compromise such as delay, and power consumption trade-off. Some work considers an aggregated objective to have a flexible trade-off such as a weighted average of the power consumption and delay, or a power consumption per unit traffic load ratio. Some other works involve constraining the performance degradation within a predefined acceptable range, closely approaching the allowable maximum, to minimize power consumption.

While existing methods offer various strategies for base station switching, they either reply on pre-defined performance degradation constraints that potentially overlook the real-time change in traffic or involve a complex reward or loss functions that are computationally heavy.

### SUMMARY

According to one or more embodiments, a method performed by at least one processor of a network device in communication with a plurality of base stations, the method comprises: receiving historical data collected by one or more base stations from the plurality of base stations, the historical data indicating one or more of a power consumption, handover data, and quality of service (QOS); generating, from the historical data, training data comprising a plurality of cell states and a corresponding random action for each cell state; and training one or more neural network estimators based on the training data, where the one or more neural network estimators comprise one or more of a power consumption estimator, a QoS estimator, and a handover prediction estimator, and where each base station from the plurality of base stations is associated with a respective cell.

According to one or more embodiments, a method performed by at least one processor of a network device in communication with a plurality of base stations, the method comprises: receiving traffic data from the plurality of base stations corresponding to a first time period; determining, using the traffic data as input into one or more neural network estimators, one or more of an estimated power consumption, an estimated QoS, and an estimated handover corresponding to a second time period later than the first time period; adjusting at least one of a QoS target and a QoS threshold based the one or more of the estimated power consumption, the estimated QoS, and the estimated handover; and performing one or more power saving measures based on the adjusted at least one of the QoS target and the QoS threshold.

According to one or more embodiments, a network device in communication with a plurality of base stations, comprises a memory; processing circuitry coupled to the memory, wherein the processing circuitry is configured to: receive historical data collected by one or more base stations from the plurality of base stations, the historical data indicating one or more of a power consumption, handover data, and quality of service (QOS), generate, from the historical data, training data comprising a plurality of cell states and a corresponding random action for each cell state, and train one or more neural network estimators based on the training data, where the one or more neural network estimators comprise one or more of a power consumption estimator, a QoS estimator, and a handover prediction estimator, and where each base station from the plurality of base stations is associated with a respective cell.

According to one or more embodiments, a network device in communication with a plurality of base stations, the network device comprising: a memory; processing circuitry coupled to the memory, wherein the processing circuitry is configured to: receive traffic data from the plurality of base stations corresponding to a first time period; determine, using the traffic data as input into one or more neural network estimators, one or more of an estimated power consumption, an estimated QoS, and an estimated handover corresponding to a second time period later than the first time period; adjust at least one of a QoS target and a QoS threshold based the one or more of the estimated power consumption, the estimated QoS, and the estimated handover; and perform one or more power saving measures based on the adjusted at least one of the QoS target and the QoS threshold.

### BRIEF DESCRIPTION OF DRAWINGS

Further features, the nature, and various advantages of the disclosed subject matter will be more apparent from the following detailed description and the accompanying drawings in which:

FIG. 1 is a diagram of an example network device in accordance with various embodiments of the present disclosure;

FIG. 2 is a schematic diagram of an example wireless communications system, in accordance with various embodiments of the present disclosure;

FIG. 3 illustrates a spatial layout of a system of base stations with corresponding sectors and cells, in accordance with various embodiments of the present disclosure.

FIG. 4 illustrates a flow chart of an example process for performing adaptive dynamic programming, in accordance with various embodiments of the present disclosure.

FIG. 5 illustrates a flow chart of an example process for performing an offline phase of the adaptive dynamic programming, in accordance with various embodiments of the present disclosure.

FIG. 6 illustrates a flow chart of an example process for performing an online phase of the adaptive dynamic programming, in accordance with various embodiments of the present disclosure.

FIG. 7 illustrates an example base station management system, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to using an adaptive dynamic programming (ADP) process utilizing prior knowledge about an environment including traffic and QoS patterns to have adaptability and computational efficiency. Compared to RL-based methods, embodiments of the present disclosure offer enhanced performance by leveraging prior knowledge such as traffic patterns of the dynamic environment. While RL methods may incorporate prior knowledge, the embodiments of the present disclosure integrate the prior knowledge directly into the process of approximating the cost-to-go value function facilitating decisions approaching a theoretical optimality. The embodiments of the present disclosure are more computationally efficient and more sample efficient for a small action space compared to RL methods with faster training and convergence by a value function approximation.

The embodiments of the present disclosure formulate the energy saving problem as a sequence of decision-making processes involving the selection of cells to switch off within a dynamic traffic environment, while considering tradeoffs between conflicting objectives of minimizing power consumption and maintaining the QoS.

In the management system of base station infrastructure, the target application includes, but is not limited to, an AI-based optimization method for switching on/off cells of base stations to save energy while ensuring adequate Quality of Service (QOS). The embodiments of the present disclosure may employ three neural networks (NN) estimators that are trained on sufficient diverse historical data. The ADP process with NN estimators may be provided to users based on real-time traffic data to predict cell-level power consumption, QoS, and handovers to perform the cell-level switch on/off actions with the minimal predicted power consumption with the predicted QoS above a target QoS. The target QoS may be adaptive based on predicted handovers of each potential action, and on-going QoS records, where an increase in predicted handovers indicates higher user demand or recent cell switching activities, which signals a potential need for stricter QoS thresholds, and conversely, consistently high recorded QOS suggests a more lenient QoS threshold can be maintained without compromising service quality.

According to one or more embodiments, neural network-based estimators are utilized. In one or examples, the ADP process combines two multilayer perceptron (MLP) estimators and a long short-term memory (LSTM) estimator, trained on widely distributed historical traffic and action data, to perform power consumption and handover estimation, resulting in a reliable approximation of a value function.

According to one or more embodiments, an online optimization for a QoS constraint adjustment is employed, utilizing real-time cumulative QoS records during interactions with the environment to determine an adaptive target QoS, which allows for adaptive target online adaptation resulting in responsiveness to fluctuating network conditions for optimizing energy savings while maintaining desired QoS levels in a wireless network.

The embodiments of the present disclosure use neural network-based estimators. The predictions from the neural network estimators may be used to forecast the future power consumption, QoS, handovers given the current traffic load on each cell, and all the potential cells on/off actions, preemptively adjust QoS settings and select the cell-level on/off action that predicted to have the lowest power consumption.

The embodiments of the present disclosure use adaptive target QoS thresholds. For example, instead of sticking to static QoS levels, the adaptive QoS thresholds adjust in real-time to changing network conditions, utilizing predicted handovers and on-going monitored QoS, enabling enhanced energy saving opportunities while maintaining adequate QoS.

The embodiments of the present disclosure have broad applicability. For example, in addition to a simulated environment, the embodiments of the present disclosure may be applied to various wireless network configurations, accommodating different traffic scenarios and QoS metrics following an identical or similar pipeline.

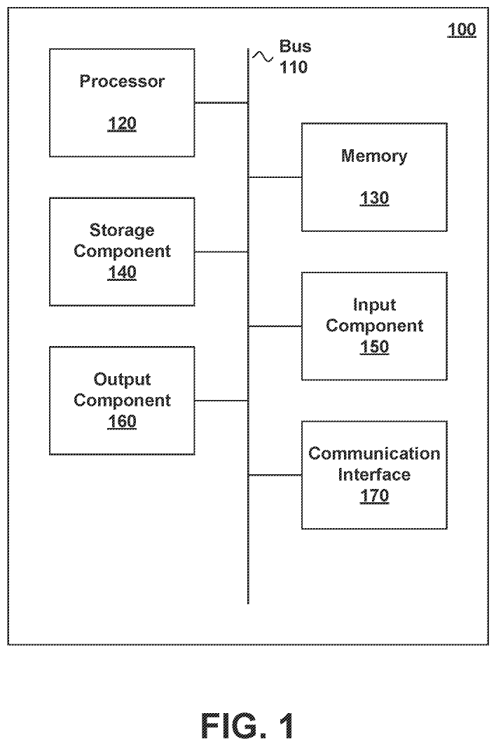

FIG. 1 is a diagram of an example device for performing translation services. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, and the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be affected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may be included in the core network 240 and perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

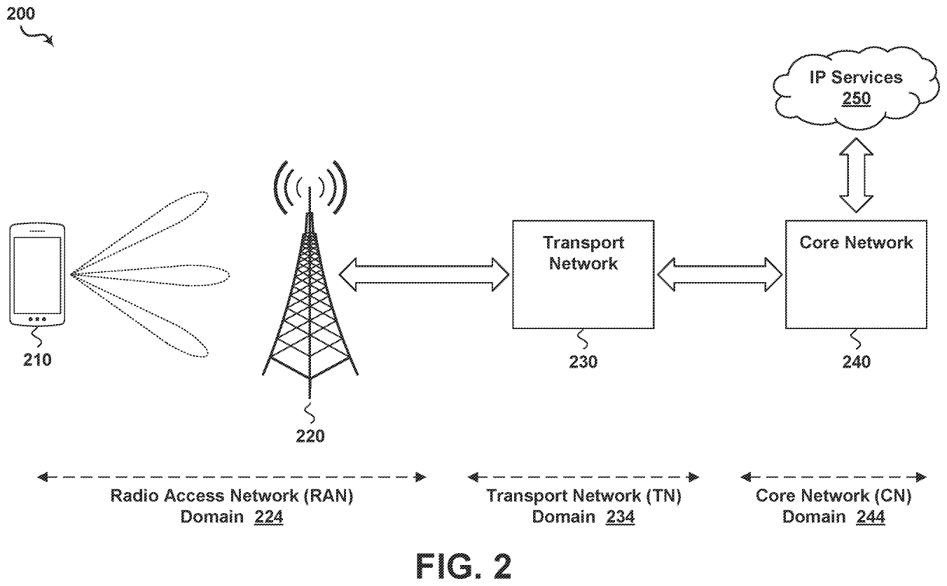

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240. The device 100 (FIG. 1) may be incorporated in the UE 210 or the base station 220.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IoT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. As an example, the core network 240 performs the translation service. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

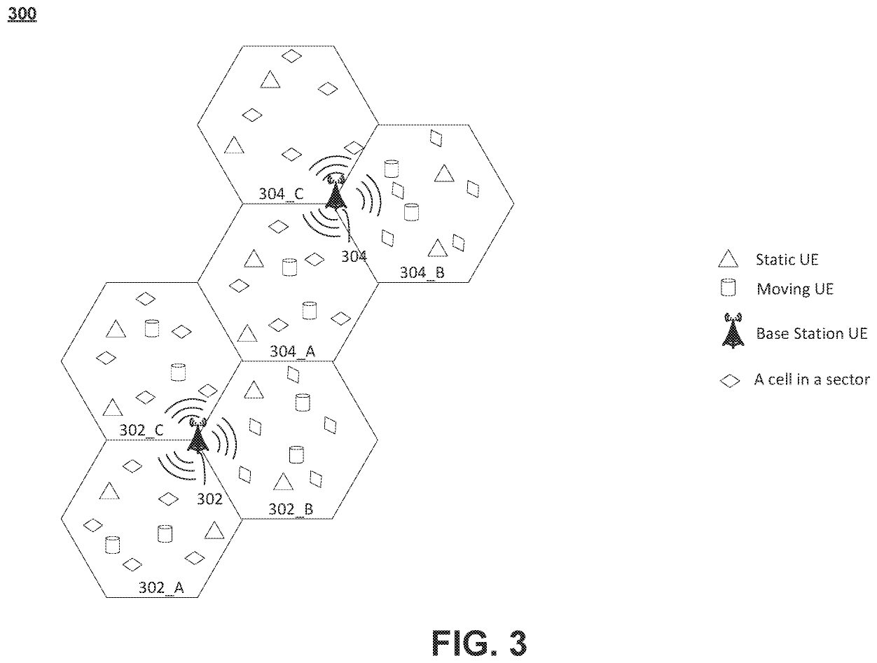

The embodiments of the present disclosure may be applied to any wireless network that includes multiple base stations B₁, . . . , B_{K}. FIG. 3 illustrates an example wireless network 300 that includes base stations 302 and 304. In one or more examples, each of base stations 302 include three sectors. For example, base station 302 includes sectors 302_A, 302_B, and 302_C, and base station 304 includes sectors 304_A, 304_B, and 304_C. Each sector may be a hexagonal layout, or any other suitable layout known to one of ordinary skill in the art. As illustrated in FIG. 3, each sector includes 5 cells. As illustrated in FIG. 3, the sectors may include one or more static UEs and one or more moving UEs. Although only two base stations are illustrated in FIG. 3, as understood by one of ordinary skill in the art, the wireless network 300 may include any desired number of base stations. Furthermore, each base station may include any desired number of sectors, and each sector may be configured with any desired number of cells.

In one or more examples, each base station serves UEs in three sectors (hexagonal regions), and each sector has five frequency carriers each of which correspond to a cell. The same frequency carriers may be shared for the sectors of all the base stations. In one or more examples, a cell (e.g., a particular carrier in a particular base station) may be denoted as C_{k,i,j}: the cell j, at the sector i of the base station Bₖ. The load ratio of a cell at this time step t may be denoved as

$${λ}_{k , i , j}^{t} = \frac{{N}_{k , i , j}^{k}}{{M}_{j}} ∈ [ 0 , 1 ] ,$$

where Mⱼ is the maximum total physical resource blocks (PRBs) of a cell j, which is the same for all cells of the same frequency. The variable N̅_{k,i,j}^{t} is the total PRBs allocated to the users at time t of the cell C_{k,i,j}. The power consumption of a cell C_{k,i,j} given a load may be expressed as:

$${P}_{k , i , j}^{t} = {e}_{k , i , j}^{t} \cdot ( P {1}_{j} + {λ}_{k , i , j}^{t} P {2}_{j} ) + ( 1 - {e}_{k , i , j}^{t} ) \cdot P {0}_{j} + {Δ}_{t} , \qquad Eq . ( 1 )$$

where e_{k,i,j}^{t}=1 when C_{k,i,j} is on and e_{k,i,j}^{t}=0 when C_{k,i,j} is off at time step t.

In one or more examples, e_{k,i,0}^{t} may be set to 1 at all times, which corresponds to the cell with the lowest frequency, and therefore, the largest coverage range. This constraint may be set to guarantee coverage. The variable P1ⱼ represents the standby power consumption of an active cell j even with zero traffic load, P2ⱼ represents the power consumption that scales linearly with the current load ratio of the cell, and P0ⱼ is sleeping power consumption when a cell is off. The variable Δₜ is the power consumption associated with switching on a cell. Δₜ=β·P_{γ} [symbol] , where β, P_{γ} are constants [symbol] (x=e_{k,i,j}^{t}−e_{k,i,j}^{t--1})=1 if x=1 else 0.

In one or more examples, to perform the optimization of reducing the power consumption with the QoS constraint, the switching on/off action uₖ^{t} to change the value of e_{k,i,j}^{t} for each time each time step t given the current state Xₖ^{t}, which is defined by a current traffic load including four variables: active UEs (UE), cell PRB load ration (N), and IP throughput (TP), appended with the current cells on/off status. Each variable may be a vector with a length equal to the number of cells in base station k. The current on/off status may be presented by eₖ^{t}=[e_{k,0,0}^{t}, . . . , e_{k,3,5}^{t}] (e.g., the status for each cell of the base stations k made by last action uₖ^{t-1}). The state Xₖ^{t} of a base station k at the time step t may be defined as Xₖ^{t}=[UEₖ^{t}, TPₖ^{t}, Nₖ^{t}, eₖ^{t}]. The QoS may be represented by a ratio of uncongested cells as follows:

$${Q}_{k}^{t} = \frac{{\sum }_{i , j} ( c = 1 if \frac{{D}_{i , j}^{t}}{{TT}_{i , j}^{t}} < τ else 0 )}{{\sum }_{i , j} ( c = 1 ) if {TT}_{i , j}^{t} > 0} . \qquad Eq . ( 2 )$$

The ratio of uncongested cells of a base station at time step t may be defined as the percent of the count c of cells with the amount of successfully transmitted data (D_{i,j}^{t}) over the transmission time (TT_{i,j}^{t}), lower than a threshold τ (e.g., 1 Mbps).

The handover of a base station k at the time step t may be defined such that UE_{k,i,j}^{t} stands for the user equipment (UE) connected to C_{k,i,j} at the time step t. In one or more examples, the handover may be defined as follows:

$${H}_{k}^{t} = {\sum }_{i = 1}^{3} {\sum }_{j = 1}^{5} \frac{\vert {UE}_{k , i , j}^{t - 1} - {UE}_{k , i , j}^{t} \vert}{2} . \qquad Eq . ( 3 )$$

According to one or more embodiments, the energy saving problem of base station cell switching may be formulated as a Markov decision process (MDP), a discrete-time stochastic control process. This formulation may be chosen since the problem involves sequential decision-making. The decision of switching may be performed at every discrete time step in a stochastic environment, where the future UE movement and demands are unknown and a trade-off is needed between minimizing the energy consumption and maintaining the QoS. Both reinforcement learning and ADP solutions may be used to find the optimal policy for MDPs. In some RL solutions, the trade-off may be considered by a reward function that combines both the power consumption and QoS quality such as the IP. In ADP solutions, the trade-off may be addressed through either Pareto optimality, which seeks Pareto optimal policies in multi-objective optimization with enhancing one objective sacrificing another, or employing constraint-based approaches that treat QoS requirement as a constraint that enforces the constraint satisfaction.

According to one or more embodiments, in the proposed method for the MDP problem, the ADP process may be applied to each base station individually (e.g., for a base station k). The optimal policy, π* minimizes the expected cumulative power consumption over the T time steps and satisfies the QOS constraint.

$${π}^{*} = arg {min}_{π} 𝔼 [ {\sum }_{t = 0}^{T} C ( {X}_{k}^{t} , π ( {X}_{k}^{t} ) ) ] s . t . ∀ t , 𝔼 [ Q ( {X}_{k}^{t} , π ( {X}_{k}^{t} ) ) ] > {Q}_{τ} . \qquad Eq . ( 4 )$$

Under a dynamic programming setting, we have a cost-to-go value function denoted as Jₜ(Xₖ^{t}) representing the expected minimal total cost of completing this energy saving problem from a given time step t until the last time step T to iteratively solve to obtain the optimal policy.

$${J}_{t} ( {X}_{k}^{t} ) = {min}_{{u}_{k}^{t}} 𝔼 [ C ( {X}_{k}^{t} , {u}_{k}^{t} ) + {J}_{t + 1} ( {X}_{k}^{t + 1} , {u}_{k}^{t} ) ] s . t . \\ ∀ t , 𝔼 [ Q ( {X}_{k}^{t} , {u}_{k}^{t} ) ] > {Q}_{τ} . \qquad Eq . ( 5 )$$

In one or more examples, the traffic load has a finite space of Λ, which is expected to be large. The cost-to-go function in Eq. (5) exhibits a large state and action space of T×|Λ|×|U|(2^{3×4}) that may cause a high computational complexity. In the ADP process, the cost-to-go value function may be approximated by less complex, more computationally efficient functions to deal with the large state and action space. The approximation allows finding near-optimal solutions to the problem and the methods of approaching include kernel-based functions and neural networks-based functions.

According to one or more embodiments, given the traffic load Xₖ^{t} and possible cell switch on/off action uₖ^{t} at time t, three neural network-based estimators for approximation. The first estimator may be a Power Consumption Estimator: \tilde{P}(Xₖ^{t}, uₖ^{t}). The second estimator may be a QoS estimator: \tilde{Q}(Xₖ^{t}, uₖ^{t}). The third estimator may be a Handover Prediction Estimator: \tilde{H}(Xₖ^{t}, eₖ^{t--1}, uₖ^{t}).

In one or more examples, a MLP may be employed to predict the power consumption, while a second MLP may be employed to predict the QoS represented by the ratio of uncongested cells given all possible pairs of [Xₖ^{t}, uₖ^{t}], ∀uₖ^{t}∈U at each time step t. In one or more examples, an LSTM may be used to predict the handover with the input with also eₖ^{t-1}, the cells on/off state of the last time step. MLPs may be chosen to predict power consumption and QoS due to the ability to capture the non-linear relation between the given pair of cell state and action [Xₖ^{t}, uₖ^{t}], to the output power consumption and QoS as demonstrated in prior studies. LSTM is a type of recurrent neural network that may effectively capture temporal dependencies in sequential data compared to an MLP. In one or more examples, LSTM is combined since handovers are influenced by the temporal dynamics of UE demands and also the cell on/off state of the previous time step. In one or more examples, the estimators may be trained on the historical data containing a sufficiently rich combination of the input states and actions, and the output ground truth of power consumption, QoS, and handovers. The optimal action uₖ^{t}* may be selected as the action with the lowest predicted power consumption among all the actions with predicted QoS above the QoS constraint Q_{τ}^{t}.

$${u}_{k}^{t *} = arg {min}_{{u}_{k}^{t}} ( {\tilde{P}}_{k}^{t} ) s . t . {\tilde{Q}}_{k}^{t} \geq {Q}_{τ}^{t} \qquad Eq . ( 6 )$$

The dynamic QoS constraint (threshold) Q_{τ}^{t} may be generated via an adaptive QoS threshold function that utilizes predicted handover and current QoS as inputs for online optimization. Predicted handover is employed for determining the QoS threshold, as an increase in handover directly results from the higher UE demand, migration and cell on/off switching. A fixed threshold does not adequately adapt to changing states, leading to suboptimal decisions in balancing energy savings and QoS. By incorporating predicted handovers into the adaptive QoS threshold function, traffic and action variations may be better accommodated. As understood by one of ordinary skill in the art, increased handovers may indicate a higher traffic load or a recent action that switches off numerous cells, implying a need for stricter QoS thresholds to prevent QoS degradation.

According to one or more embodiments, given the average (on all the actions) predicted handover H̅^{t}, the parameters θ* may be updated to minimize a difference between the target QoS Q_{ϕ}^{t}, and the threshold Q_{τ}^{t}.

$${θ}^{*} = arg {min}_{θ} [ {( {Q}_{ϕ}^{t} - {Q}_{τ}^{t} )}^{2} + γ {‖ θ ‖}^{2} ] , \qquad Eq . ( 7 )$$

Where θ represents the adjustable parameters of a function, g_{θ} models the relationship between the predicted average handovers H̅^{t} and the adaptive QoS threshold Q_{τ}^{t}. The variable γ∥θ∥² is a regularization squared Euclidean norm of the parameter vector to prevent overfitting.

$${Q}_{τ}^{t} = {g}_{θ} ( {\overline{H}}^{t} ) = {θ}_{0} + {θ}_{1} {\overline{H}}^{t} \qquad Eq . ( 8 )$$

In one or more examples, a linear function g_{θ} with an objective function updated by gradient descent may be utilized. The variable θ₀ represents the intercept (e.g., the QoS threshold when no handovers), and θ₁ represents the slope (e.g., how the QoS threshold changes with respect to the handover). The bounds for θ₀, θ₁ for the optimization to yield practical results are presented in Table II (FIG. 9), which is described in further detail below.

$$L ( θ ) = {( {Q}_{ϕ}^{t} - ( {θ}_{0} + {θ}_{1} {\overline{H}}^{t} ) )}^{2} + γ {‖ θ ‖}^{2} \qquad Eq . ( 9 )$$

The adaptive target QoS Q_{ϕ}^{t} may be calculated as: Q_{ϕ}^{t}=Q_{ϕ}+Q_{δ}^{t}, where Q_{ϕ} denotes a constant target QoS, Q_{δ}^{t} represents a subtraction between the target QoS and the on-going QoS observed (e.g., the average of the QoS(s) of all the previous time steps). The variable Q_{δ}^{t} is positive/negative when the observed QoS is lower/higher than the target QoS, which will adjust Q_{ϕ}^{t} accordingly. In one or more examples, θ₀ and θ₁ learned at time step t may be utilized along with the handovers at the next step for determining the action. For example, the learned parameters and handover may be utilized for determining the QoS threshold Q_{τ}, where the QOS threshold will be used to determine a list of actions that may be taken (with predicted QoS>Qos threshold). After the list of actions is determined, one action from the list with minimal predicted power consumption may be selected. In one or more examples, the optimization at each time step takes place after the action is made, adjusting θ₀ and θ₁ based on Q_{ϕ}^{t} which is adjusted to prioritize either energy savings or QoS improvements based on the ongoing QoS records during the online optimization, to improve energy saving while maintaining the QoS levels.

According to one or more embodiments, in addition to the aforementioned estimators that are trained on historical data to estimate the estimated values of power consumption and QoS, Certainty Equivalent Control (CEC) may be applied, which replaces Jₜ₊₁(Xₖ^{t+1}, uₖ^{t}) in Eq. (5) with its expected value \tilde{J}ₜ₊₁(X̅ₖ^{t+1}, uₖ^{t}) to further simplify the control strategy. In one or more examples, CEC transfers the stochastic state transition in the next time step cost Jₜ₊₁ to be deterministic to further reduce the computational cost. The variable X̅ₖ^{t+1} will be the mean traffic from historical data at a certain time step using the estimators to store a table of \tilde{J}ₜ₊₁(X̅ₖ^{t+1}, uₖ^{t}), ∀t, uₖ^{t}∈U (e.g., an offline phase of ADP). The mean traffic of historical data is used due to a reasonable assumption that the user traffic demands follow certain periodic patterns throughout one daytime. In the offline phase, the expected cost-to-go function may be calculated as the following, where Q_{τ′} is a constant, Δᵤ_{ₖ}_{^{t}} is the on/off state transition cost associated with switching on additional cells.

$${\overline{J}}_{t} ( {\overline{X}}_{k}^{t} , {u}_{k}^{t} ) = {min}_{{u}_{k}^{t}} [ \overline{P} ( {X}_{k}^{t} , {u}_{k}^{t} ) + {\overline{J}}_{t + 1} ( {\overline{X}}_{k}^{t + 1} , {u}_{k}^{t} ) + {Δ}_{{u}_{k}^{t}} ] \\ S . T . {\overline{Q}}_{k}^{t} \geq {Q}_{τ′} . \qquad Eq . ( 11 )$$

In Eq. (11), Q_{τ′} may be a constant set to a predetermined value (e.g., 80)

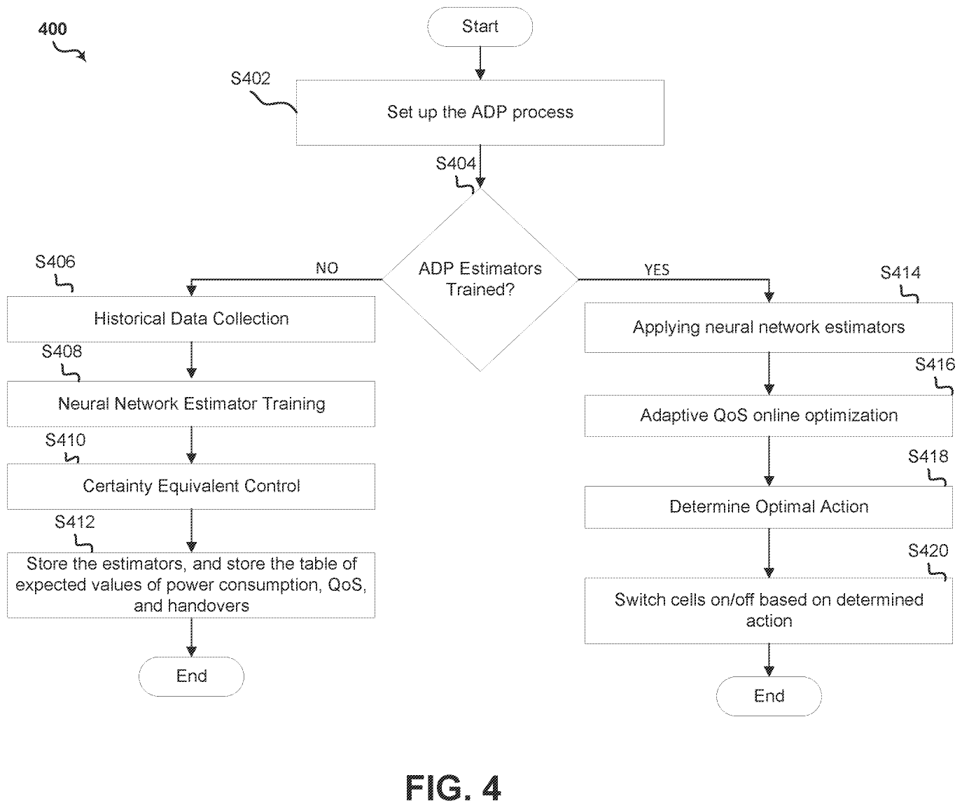

FIG. 4 illustrates a flowchart of an example process 400 for performing the ADP process, in accordance with one or more embodiments. In one or more examples, the process 400 may be performed by processor 120 (FIG. 1). In one or more examples, the process 400 may be performed by a processor 120, where the processor 120 may be incorporated in a network controller device that is in communication with a plurality of base stations.

The process 400 may start at operation S402 where the ADP process is set up. The set up may include initializing one or more thresholds, initializing one or more neural network estimators, initializing one or more network parameters, initializing one or more CEC tables for expected values.

The process proceeds to operation S404 where it is determined if the ADP estimators are trained. If the ADP estimators are not trained (N), the process proceeds to operation S406, where the offline phase of the ADP process is performed.

In operation S406, historical data collection is performed. The historical data collection may include collecting base station cell-level historical power consumption, QoS, and handover data for all possible actions on various scenarios of various X-day traffic load conditions for every N minute interval. In one or more examples, the X-day traffic load conditions may be for one day, and the N minute interval may be 15 minutes.

In operation S408, neural network estimator training is performed. For example, the neural network estimator training may include training of a power consumption estimator (MLP), a QoS estimator (MLP), and a handover prediction estimator (LSTM).

The process proceeds to operation S410 where certainty equivalent control may be performed. For example, certainty equivalent control may include replacing a stochastic state with a deterministic expected value, as described above.

The process proceeds to operation S412, where the estimators are stored, and the table of expected values of power consumption, QoS, and handovers are stored.

Returning to operation S404, if it is determined that the ADP estimators are trained, the online phase of the ADP process may be performed where the process proceeds to operation S414.

In operation S414, the neural network estimators are applied. For example, the neural network estimators that are trained in the offline phase may be applied to predict power consumption, QoS and handover given the current cell traffic load for the current timestamp.

The process proceeds to operation S416, where adaptive QoS online optimization is performed. For example, a QoS target and QoS threshold may be adjusted based on predicted handovers and a current QoS. For example, when there are three cells, the total number of actions that may be performed is 8 (e.g., 2³ combinations of cells being turned on or turned off). The QoS threshold may initially be set to X. However, if the QoS threshold X is set too high, only 2 of the 8 total number of actions may be performed, which may degrade the QoS. Based on the ADP process, it may be determined that lowering X to a lower threshold value may enable 5 of the 8 total number of actions where power consumption is minimized and QoS is optimized.

The process proceeds to operation S418, where an optimal action is determined. In one or more examples, an optimal action may be computed based on power consumption, handover prediction, and the QoS estimators. The process proceeds to operation S420, where one or more cells are switched on/off based on the determined action. For example, it may be determined to turn off one or more cells that minimize power while maintaining a QoS over a threshold.

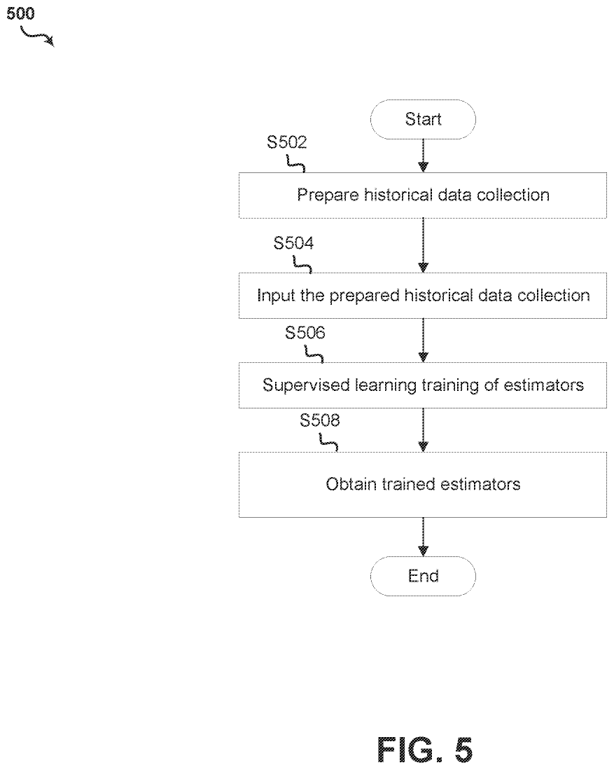

FIG. 5 illustrates a flow chart of an example process 500 for training neural network estimators. In one or more examples, the process 500 may be a sub-process of operation S408 (FIG. 4).

The process 500 may start at operation S502 where historical data is prepared. In one or more examples, a simulator is run for each scenario of 8 preset scenarios. Each preset scenario may correspond to a different observed traffic pattern that occurs in a 24 hour period. At every time step t, a cell state Xₖ^{t} is loaded, and a random action uₖ^{t} is selected. In one or more examples, a cell state Xₖ^{t} may be a tuple of active UEs, IP throughput, cell PRB load ratio, and current on/off status. In one or more examples, when there are three cells, there may be 8 (e.g., 2³) available random actions corresponding to the number of combinations of turning a cell on/off. This procedure may be repeated for the same scenario 64 times to gather a diverse set of samples, which ensures a low probability (approximately 1.6%) that any one action is never selected. This procedure may be applied to each sector associated with a base station.

The process proceeds to operation S504 where the prepared historical data collection is inputted. For example, a specific cell state Xₖ^{t}, random action uₖ^{t}, and previous time step cell state e_{k,i,j}^{t-1} are inputted to a simulator.

The process proceeds to operation S506 where supervised learning training of estimators is performed. For example, the neural network estimators may be trained using the generated data with diverse combinations of input states and actions. In this regard, the generated data with diverse combinations of input states and actions, together with the ground truth of power consumption, QoS, and handovers, may be used as the input to train the estimators. The training results in the trained estimators, which may be used in the online phase.

The process proceeds to operation S508 to obtain the trained estimators. The trained estimators may include a power consumption estimator using MLP, a QoS estimator using MLP, and a handover prediction estimator using MLP.

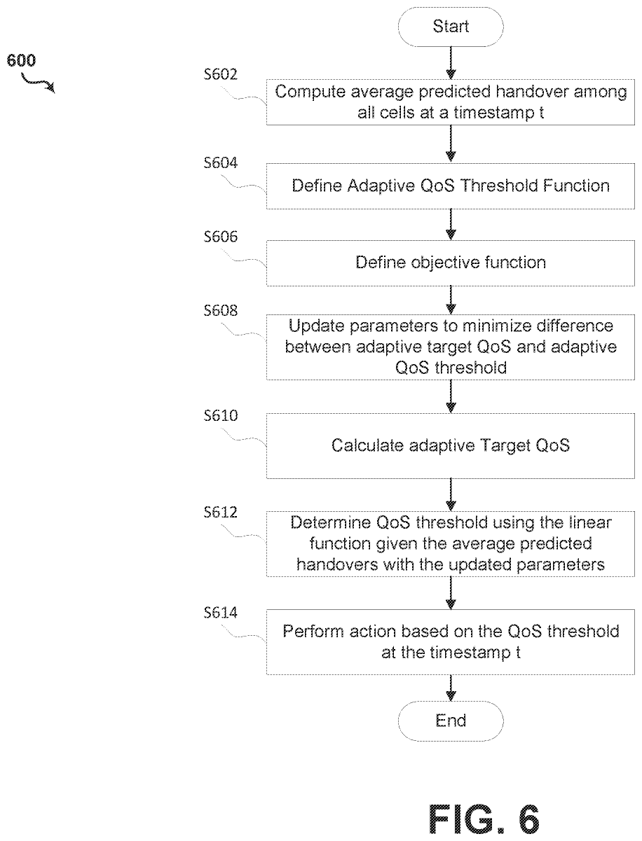

FIG. 6 illustrates a flow chart of an example process 600 for performing adaptive QoS online optimization. In one or more examples, the process 600 may be a sub-process of operation S416 (FIG. 4).

The process 600 may start at operation S602 where an average predicted handover among all cells at timestamp t is computed. In one or more examples, if there are three cells, and the number of predicted handovers in the three cells are 3, 4, 2, the average predicted handover H̅^{t} is among all three cells is 3.

The process proceeds to operation S604 where an adaptive QoS threshold function is defined. For example, the adaptive QoS threshold Q_{τ}^{t} is defined in accordance with Eq. 8 described above.

The process proceeds to operation S606, where the objective function is defined. For example, the objective function L(θ) may be defined in accordance with Eq. (9) discussed above.

The process proceeds to operation S608 where parameters are updated to minimize a difference between the adaptive target QoS and the adaptive QoS threshold. For example, the parameters θ* may be updated to minimize a difference between the target QoS Q_{ϕ}^{t}, and the threshold Q_{τ}^{t} based on Eq. (7) disclosed above.

The process proceeds to operation S610 where the adaptive target QoS is calculated. For example, the adaptive target QoS Q_{ϕ}^{t} may be calculated as: Q_{ϕ}^{t}=Q_{ϕ}+Q_{δ}^{t}, where Q_{ϕ} denotes a constant target QoS, Q_{δ}^{t} represents a subtraction between the target QoS and the on-going QoS observed (e.g., the average of the QoS(s) of all the previous time steps).

The process proceeds to operation S612 where a QoS threshold is determined using a linear function given the average predicted handovers with the update parameters. For example, the QoS threshold Q_{τ}^{t} may be determined in accordance with Eq. (8) using the updated parameters θ*. The process proceeds to operation 618 where an action is performed based on the new QoS threshold Q_{τ}^{t} at time step t. For example, one or more cells may be turned on/off to minimize power consumption while maintaining a QoS.

In one or more examples, a QoS target may be adjusted based on a predefined constant initial target and observed QoS records up to the current timestamp. The parameters of a function for mapping handovers to QoS thresholds using an objective function given the adjusted QoS target may be updated. Subsequently, the QoS threshold may be adjusted using the function with the updated parameters and given the estimated handover.

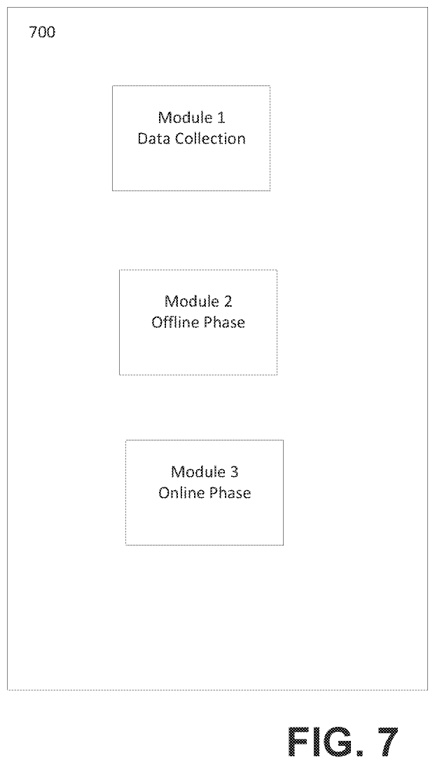

FIG. 7 illustrates an example base station management system 700. In one or more examples, the base station management system 700 may be implemented by a processor 120 (FIG. 1) included in a network controller that is in communication with one or more base stations. The base station management system 700 may include Module 1 for data collection, Module 2 for the offline phase of the ADP process, and Module 3 for the online phase of the ADP process.

In one or more examples, Module 1 may accept as input raw cell-level historical recorded non standardized data from a base station or a simulator including for example traffic, PRB usage, delays, power consumed, etc. Based on the raw-cell level historical data, Module 1 may output processed 15-min intervals data packets including traffic state, actions, power consumption, QoS, on/off status, handovers for each cell, to be used to train the neural network estimators.

In one or more examples, Module 1 may implement a 5G network simulator. The 5G network simulator may load in read-world scenarios (e.g., 8 scenarios of different traffic patterns in a 24 hour period) of various heavy or light daily traffic conditions to mimic real-world 5G traffic patterns. The Module 1 may accept as input raw historical recorded traffic scenarios data and one or more simulator configurations. Based on this input, Module 1 may output simulator output data including active UEs, IP throughput, cell PRB load ratio, power consumption, metrics of delay, cell on/off status.

In one or more examples, Module 1 may implement a time-step data processor that loads simulated output data and process (e.g., calculate QoS, and handovers based on metrics of delay and active UEs) at 15-min intervals for each timestep for 96 timesteps (e.g., 24 hours), to be ready to be the input for the ADP process. The input may be the simulator output data. The output may be processed data packets for 96 timestamps of 15-min intervals (24 hours) including: a cell state (e.g., a tuple of active UEs, cell physical resources blocks (PRBs), IP throughput, cell on/off status), power consumption, QoS, cell on/off status, and/or handovers for each cell.

According to one or more embodiments, Module 2 may receive as input the processed 15-min intervals data packets of traffic state, actions, power consumption, QoS, handovers data. Module 2 may output the trained estimators and the generated table of expected values of power consumption, QoS, and handovers with certainty equivalent control.

In one or more examples, Module 2 may perform neural network estimator training. The neural network estimator training may utilize a diverse combination of input states, random generated actions (e.g., actions), and ground truth outputs. The training phase may employ neural network-based estimators to learn the relationships between the given pair of traffic state and action. Module 2 may receive as input, for performing the training, historically processed data packets of cell-level traffic load, on/off state, power consumption, QoS, and/or handovers for all actions in the defined action space for 15-minute interval timestamps for a day. The output trained neural network models may include a Power consumption estimator (MLP), a QoS estimator (MLP), and a (iii) Handover prediction estimator (LSTM).

In one or more examples, Module 2 may perform certainty equivalent control for expected value generation. During the offline phase of the ADP process, certainty equivalent control may be used to replace the stochastic state with a deterministic expected value, which is analogous to deducing that under specific traffic loads, certain actions will result in predictable power consumption and/or QoS, which enhances the efficiency during the online phase of the ADP process.

In one or more examples, for certainty equivalent control, Module 2 may accept as input the trained estimator models, a whole space of cell states Xₖ^{t} and actions uₖ^{t}, and a constant QoS threshold Q_{τ}^{t}. The output of Module 2 may be a deterministic cost-to go value function for the expected values \tilde{J}ₜ(X̅ₖ^{t}, uₖ^{t}) (e.g., Eq. (11)) of total cost of power consumption from timestamp t to the last time step with minimal cost of the expected value, and satisfying the QoS threshold to help make decision on which action to take in the online phase.

According to one or more embodiments, Module 3 receives as input current real-time cell state and cell on/off status. Using the trained neural network estimators, Module 3 may output an execution of a decided action such as switch on/off on each cell of a base station (e.g., base station cell on/off status is updated).

In one or more examples, Module 3 may provide real-time traffic data preprocessing. The preprocessing of incoming traffic data may include preparing the data in a same format (15-minute timestamp) as in the offline phase, to enable the processed data ready for the subsequent ADP neural network estimators to make predictions. Module 3 may receive as input real-time traffic data and current cells on/off status. Module 3 may output a processed real-time cell state at a base station Xₖ^{t} at each timestamp t for base station k.

In one or more examples, Module 3 may apply the neural network estimators in the online phase of the ADP process. Module 3 may leverage the trained estimators to provide predictions on power consumption, QoS, and handovers based on the preprocessed incoming real-time traffic state. The neural network estimators may receive as input the preprocessed real-time traffic state Xₖ^{t} and all potential actions uₖ^{t}. The neural network estimators may output a predicted power consumption \tilde{P}, a predicted QoS \tilde{Q}, and/or predicted handovers \tilde{H} for each action uₖ^{t}.

In one or more examples, Module 3 may perform adaptive QoS online optimization. For example, Module 3 may dynamically adjust target parameters based on the predicted handovers and just observed QoS records and the current QoS. The QoS online optimization may include (i) calculating the average predicted handover \tilde{H}^{t}, (ii) updating parameters θ to minimize the objective function L(θ), which measures the difference between adaptive target QoS Q_{ϕ}^{t} and adaptive QoS threshold Q_{τ}^{t}, and (iii) adjusting the QoS threshold Q_{τ}^{t} based on adaptive target QoS Q_{ϕ}^{t} and all observed QoS.

Module 3 may receive as input the predicted handovers \tilde{H}^{t} and all QoS observed until current QoS. Module 3 may output the adjusted θ and Q_{ϕ}^{t}, and new QoS threshold Q_{τ}^{t}.

In one or more examples, Module 3 may determine an optimal action. For example, Module 3 may select an action uₖ^{t} with minimal power consumption (including the cell switching cost Δ) satisfying the QoS threshold Q_{τ}^{t}. Module 3 may receive as input real-time traffic data Xₖ^{t} all possible cells on/off actions uₖ^{t}, QoS threshold Q_{τ}^{t}, predicted power consumption \tilde{P}, predicted QoS \tilde{Q}, predicted handovers \tilde{H}, and certainty equivalent control table J. Module 3 may output the selected optimal action uₖ^{t}* for the base station k.

In one or more examples, Module 3 may execute an action on the base station after determining the action for the ADP process to execute on the base station. The execution may reflect in an updated cell on/off state of the base station in the next time stamp t+1. Module 3 may accept as input the selected optimal action uₖ^{t}*, and output confirmation of action execution and/or an updated base station state.

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor of a network device in communication with a plurality of base stations, the method comprising: receiving historical data collected by one or more base stations from the plurality of base stations, the historical data indicating one or more of a power consumption, handover data, and quality of service (QoS); generating, from the historical data, training data comprising a plurality of cell states and a corresponding random action for each cell state; and training one or more neural network estimators based on the training data, in which the one or more neural network estimators comprise one or more of a power consumption estimator, a QoS estimator, and a handover prediction estimator, and in which each base station from the plurality of base stations is associated with a respective cell.
(2) The method of feature (1), in which each cell state indicates a different traffic pattern for a plurality of cells.
(3) The method of feature (1), in which the corresponding random action includes turning off at least one cell while one or more cells remain turned on.
(4) The method of feature 1, in which the corresponding random action includes turning on at least one cell while one or more cells remain turned off.
(5) The method of any one of features (1)-(4), in which the generating the training data further comprises: converting the historical data to processed N minute interval data packets, each data packet comprising, for at least one cell, a cell state, power consumption, on/off status and handovers.
(6) The method of any one of features (1)-(5), further comprising: performing certainty equivalent control that replaces a stochastic cost-to-go value function with a deterministic cost-to-go value function, in which the stochastic cost-to-go value function represents an expected minimal total cost of completing an energy saving solution for a time step t to a last time step T.
(7) The method of any one of features (1)-(6), in which the one or more neural network estimators is the power consumption estimator, in which the power consumption estimator is a multilayer perceptron (MLP) neural network.
(8) The method of any one of features (1)-(7), in which the one or more neural network estimators is the QoS estimator, in which the QoS estimator is a multilayer perceptron (MLP) neural network.
(9) The method of feature (1)-(8), in which the one or more neural network estimator is the handover prediction estimator, in which the handover prediction estimator is a long short-term memory (LSTM) neural network.
(10) A method performed by at least one processor of a network device in communication with a plurality of base stations, the method comprising: receiving traffic data from the plurality of base stations corresponding to a first time period; determining, using the traffic data as input into one or more neural network estimators, one or more of an estimated power consumption, an estimated QoS, and an estimated handover corresponding to a second time period later than the first time period; adjusting at least one of a QoS target and a QoS threshold based the one or more of the estimated power consumption, the estimated QoS, and the estimated handover; and performing one or more power saving measures based on the adjusted at least one of the QoS target and the QoS threshold.
(11) The method according to feature (10), in which the one or more power saving measures comprise switching off the one or more cells associated with the plurality of base stations.
(12) The method according to feature (10) or (11), the method further comprising: determining an average predicted handover for each cell during the first time period; and minimizing, based on the determined average predicted handover, an objective function that measures a difference between an adaptive target QoS and an adaptive QoS threshold, in which the adjustment of at least one of the QoS target and the QoS threshold is further based on the minimized objective function.
(13) The method according to any one of features (10)-(12), in which the received traffic data is processed into 15 minute interval packets to generate processed data comprising at least one of a traffic state, power consumption, QoS, and handover data, and in which the processed data is input into the one or more neural network estimators.
(14) The method according to any one of features (10)-(13), in which the one or more neural network estimators comprises a power consumption estimator, in which the power consumption estimator is a multilayer perceptron (MLP) neural network.
(15) The method according to any one of features (10)-(14), in which the one or more neural network estimators comprises a QoS estimator, in which the QoS estimator is a multilayer perceptron (MLP) neural network.
(16) The method according to any one of features (10)-(15), in which the one or more neural network estimators comprises a handover prediction estimator, in which the handover prediction estimator is a long short-term memory (LSTM) neural network.
(17) A network device in communication with a plurality of base stations, the network device comprising: a memory; processing circuitry coupled to the memory, in which the processing circuitry is configured to: receive historical data collected by one or more base stations from the plurality of base stations, the historical data indicating one or more of a power consumption, handover data, and quality of service (QoS), generate, from the historical data, training data comprising a plurality of cell states and a corresponding random action for each cell state, and train one or more neural network estimators based on the training data, in which the one or more neural network estimators comprise one or more of a power consumption estimator, a QoS estimator, and a handover prediction estimator, and in which each base station from the plurality of base stations is associated with a respective cell.
(18) The network device of feature (17), in which each cell state indicates a different traffic pattern for a plurality of cells.
(19) The network device of feature (17), in which the corresponding random action includes turning off at least one cell while one or more cells remain turned on.
(20) A network device in communication with a plurality of base stations, the network device comprising: a memory; processing circuitry coupled to the memory, in which the processing circuitry is configured to: receive traffic data from the plurality of base stations corresponding to a first time period; determine, using the traffic data as input into one or more neural network estimators, one or more of an estimated power consumption, an estimated QoS, and an estimated handover corresponding to a second time period later than the first time period; adjust at least one of a QoS target and a QoS threshold based the one or more of the estimated power consumption, the estimated QoS, and the estimated handover; and perform one or more power saving measures based on the adjusted at least one of the QoS target and the QoS threshold.

What is claimed is:

1. A method performed by at least one processor of a network device in communication with a plurality of base stations, the method comprising:
receiving historical data collected by one or more base stations from the plurality of base stations, the historical data indicating one or more of a power consumption, handover data, and quality of service (QOS);
generating, from the historical data, training data comprising a plurality of cell states and a corresponding random action for each cell state; and
training one or more neural network estimators based on the training data,
wherein the one or more neural network estimators comprise one or more of a power consumption estimator, a QoS estimator, and a handover prediction estimator, and
wherein each base station from the plurality of base stations is associated with a respective cell.

2. The method of claim 1, wherein each cell state indicates a different traffic pattern for a plurality of cells.

3. The method of claim 1, wherein the corresponding random action includes turning off at least one cell while one or more cells remain turned on.

4. The method of claim 1, wherein the corresponding random action includes turning on at least one cell while one or more cells remain turned off.

5. The method of claim 1, wherein the generating the training data further comprises:
converting the historical data to processed N minute interval data packets, each data packet comprising, for at least one cell, a cell state, power consumption, on/off status and handovers.

6. The method of claim 1, further comprising:
performing certainty equivalent control that replaces a stochastic cost-to-go value function with a deterministic cost-to-go value function,
wherein the stochastic cost-to-go value function represents an expected minimal total cost of completing an energy saving solution for a time step t to a last time step T.

7. The method of claim 1, wherein the one or more neural network estimators is the power consumption estimator, wherein the power consumption estimator is a multilayer perceptron (MLP) neural network.

8. The method of claim 1, wherein the one or more neural network estimators is the QoS estimator, wherein the QoS estimator is a multilayer perceptron (MLP) neural network.

9. The method of claim 1, wherein the one or more neural network estimator is the handover prediction estimator, wherein the handover prediction estimator is a long short-term memory (LSTM) neural network.

10. A method performed by at least one processor of a network device in communication with a plurality of base stations, the method comprising:
receiving traffic data from the plurality of base stations corresponding to a first time period;
determining, using the traffic data as input into one or more neural network estimators, one or more of an estimated power consumption, an estimated QoS, and an estimated handover corresponding to a second time period later than the first time period;
adjusting at least one of a QoS target and a QoS threshold based the one or more of the estimated power consumption, the estimated QoS, and the estimated handover; and
performing one or more power saving measures based on the adjusted at least one of the QoS target and the QoS threshold.

11. The method according to claim 10, wherein the one or more power saving measures comprise switching off the one or more cells associated with the plurality of base stations.

12. The method according to claim 10, the method further comprising:
determining an average predicted handover for each cell during the first time period; and
minimizing, based on the determined average predicted handover, an objective function that measures a difference between an adaptive target QoS and an adaptive QoS threshold,
wherein the adjustment of at least one of the QoS target and the QoS threshold is further based on the minimized objective function.

13. The method according to claim 10, wherein the received traffic data is processed into 15 minute interval packets to generate processed data comprising at least one of a traffic state, power consumption, QoS, and handover data, and
wherein the processed data is input into the one or more neural network estimators.

14. The method of claim 10, wherein the one or more neural network estimators comprises a power consumption estimator, wherein the power consumption estimator is a multilayer perceptron (MLP) neural network.

15. The method of claim 10, wherein the one or more neural network estimators comprises a QoS estimator, wherein the QoS estimator is a multilayer perceptron (MLP) neural network.

16. The method of claim 10, wherein the one or more neural network estimators comprises a handover prediction estimator, wherein the handover prediction estimator is a long short-term memory (LSTM) neural network.

17. A network device in communication with a plurality of base stations, the network device comprising:
a memory;
processing circuitry coupled to the memory, wherein the processing circuitry is configured to:
receive historical data collected by one or more base stations from the plurality of base stations, the historical data indicating one or more of a power consumption, handover data, and quality of service (QOS),
generate, from the historical data, training data comprising a plurality of cell states and a corresponding random action for each cell state, and
train one or more neural network estimators based on the training data,
wherein the one or more neural network estimators comprise one or more of a power consumption estimator, a QoS estimator, and a handover prediction estimator, and
wherein each base station from the plurality of base stations is associated with a respective cell.

18. The network device of claim 17, wherein each cell state indicates a different traffic pattern for a plurality of cells.

19. The network device of claim 17, wherein the corresponding random action includes turning off at least one cell while one or more cells remain turned on.

20. A network device in communication with a plurality of base stations, the network device comprising:
a memory;
processing circuitry coupled to the memory, wherein the processing circuitry is configured to:
receive traffic data from the plurality of base stations corresponding to a first time period;
determine, using the traffic data as input into one or more neural network estimators, one or more of an estimated power consumption, an estimated QoS, and an estimated handover corresponding to a second time period later than the first time period;
adjust at least one of a QoS target and a QoS threshold based the one or more of the estimated power consumption, the estimated QoS, and the estimated handover; and
perform one or more power saving measures based on the adjusted at least one of the QoS target and the QoS threshold.
